(19) United States
(12) Patent Application Publication
(10) Pub. No.: US 2022/0216699 A1
(43) Pub. Date: Jul. 7, 2022

(54) DEVICE COMPRISING AT LEAST ONE RECHARGEABLE BATTERY

(71) Applicant: WEICHAI POWER CO., LTD., Weifang. Shandong (CN)

(72) Inventors: Yupeng WANG, Weifang, Shandong (CN); Wenmiao CHEN, Weifang, Shandong (CN); Thomas VETTER, Lorch (DE); Wenkai YAN, Zibo, Shandong (CN)

(21) Appl. No.: 17/608,712

(22) PCT Filed: Mar. 18, 2020
(86) PCT No.: PCT/EP2020/057378

§ 371 Date: Nov. 3, 2021

(30) Foreign Application Priority Data
May 6, 2019 (DE) 20 2019 102 519.0

(51) Int. Cl. H02J 7/00; H02J 7/34; H01M 10/48; H01M 10/46

(52) U.S. Cl. CPC H02J 7/005; H02J 7/0013; H02J 7/342; H02J 7/00712; H02P 27/06; H02J 7/00032; H01M 10/48; H01M 10/46; H02J 2207/20; H02J 7/0069

(57) ABSTRACT

The invention relates to a device (1) comprising at least one rechargeable battery (2) and an electric converter associated with said battery, which converter is connected to a superordinate system. The electric converter is designed to draw or feed electrical energy from/to the rechargeable battery (2). Characteristic variables of the rechargeable battery are determined by means of the electric converter during operation of the battery. Alternatively or additionally, means for influencing the operating mode of the rechargeable battery (2) are provided.

The invention relates to a device having at least one rechargeable battery.

In such a device, at least one rechargeable battery is connected to a superordinate system via an electric converter, which can be a DC/DC converter or a DC/AC converter, for example. By means of the electric converter, electrical energy can be drawn or fed from/into the rechargeable battery. Typically, such a device can also comprise multiple rechargeable batteries, wherein each rechargeable battery is assigned an electric converter connected to the superordinate system.

The significance of rechargeable batteries is increasing in reduced-carbon and carbon-free energy supply. This applies to both mobile applications as well as stationary applications. The mobile applications range from conventional automobiles to various types of industrial trucks through to mobile work machines and ships. The stationary applications primarily relate to the generation of electrical current as an isolated grid or for feeding into public grids.

The cost of usage per operating hour and, related to this, the service life of a rechargeable battery, are essential aspects for cost-effective use of rechargeable batteries.

The invention is based on the problem of providing a device of the aforementioned type that has a high level of functionality with low design expense.

For resolving this problem, the features of claim 1 are provided. Advantageous embodiments and useful further developments of the inventions are described in the dependent claims.

The invention relates to a device comprising at least one rechargeable battery and an electric converter assigned to said battery, which converter is connected to a superordinate system. The electric converter is designed to draw or feed electrical energy from/to the rechargeable battery. Characteristic variables of the rechargeable battery are determined by means of the electric converter during operation of the battery. Alternatively or additionally, means for influencing the operating mode of the rechargeable battery are provided.

The functionality of the device according to the invention is enhanced in that the one or more electric converters can be used for more than simply drawing or feeding energy from/to the rechargeable batteries and enabling coupling of the rechargeable battery to a superordinate system.

Rather, according to the invention, characteristic variables of the rechargeable battery can be captured by the one or more electric converters, wherein this recording takes place in-situ, i.e., directly at the device, and advantageously, takes place continuously and in a time-indexed manner. Information about the current operating status of the rechargeable battery is obtained from recording these characteristic values, which enables comprehensive control of the rechargeable battery. According to the invention, the control in question goes beyond mere ‘control’ in the sense of ‘monitoring’ the rechargeable battery. Rather, control operations can be performed, especially dependent upon the captured characteristic variables, which control operations are adapted to the current operating status of the rechargeable battery or also can optimize the operating status of the rechargeable battery.

Advantageously, the age deterioration status of the one rechargeable battery or of each of the rechargeable batteries is determined by means of the characteristic variables.

Moreover, age deterioration-related operating modes of the one rechargeable battery or of each of the rechargeable batteries are determined by means of the characteristic variables.

Finally, the operating mode of the one rechargeable battery or of each of the rechargeable batteries is influenced in such a manner so as to extend the service life of the one rechargeable battery or of each of the rechargeable batteries.

In principle, the device according to the invention can have just one rechargeable battery that is assigned an electric converter.

It is especially advantageous for the device according to the invention to have an arrangement of multiple rechargeable batteries. Each rechargeable battery is connected to the superordinate system via an electric converter.

Such an arrangement of multiple rechargeable batteries, each with an assigned electric converter, is especially suitable for controlling the operating modes of the rechargeable battery.

To this end, it is advantageous to specifically modify the operating mode of this rechargeable battery such that an operating status is achieved for it in which the service life, i.e., the useful life, of this rechargeable battery is extended. The other rechargeable batteries are then controlled such that they compensate for the modification of the operating mode of the first rechargeable battery, such that the required properties of the entire system, and especially, those of the superordinate system, are fulfilled at all times. In the case of an alternating, preferably periodical, modification of operating modes of rechargeable batteries, the control can particularly advantageously take place such that in an alternating manner, or even simultaneously, some of the rechargeable batteries within the arrangement of multiple rechargeable batteries are operated in one of these service life-extending operating modes.

To implement such a control, the single electric converter or each of the multiple electric converters can constitute a control means for influencing the operating mode of the one rechargeable battery or of each of the rechargeable batteries.

Alternatively or in addition, a control unit connected to the one electric converter or each of the multiple electric converters can be provided for influencing the operating mode of the one rechargeable battery or of each of the rechargeable batteries.

According to an advantageous embodiment, the one electric converter or each of the multiple electric converters is formed as a DC/DC converter.

In this case, the one or more DC/DC converters can be connected to a DC voltage grid, wherein this then constitutes the superordinate system.

According to an alternative embodiment, the one electric converter or each of the multiple converters is formed as a DC/AC converter.

In this case, systems with motors can be provided as the superordinate system. According to a first variant, the DC/AC converters can be connected to a motor, wherein the DC/AC converters feed different partial windings of the motor.

According to a second variant, each DC/AC converter respectively can be connected to a motor, wherein the motors are linked by a summation transmission.

According to an advantageous embodiment, sensors are provided for measuring characteristic variables, which sensors are integrated within or assigned to an electric converter.

It is advantageous for current and voltage of a rechargeable battery to be captured as characteristic variables.

To this end, to capture characteristic variables of a rechargeable battery, its charge and/or discharge current can be modified by an electric converter.

By modifying the charge and/or discharge current of the rechargeable battery, the voltage is determined upon the basis of the current.

The age deterioration status of a rechargeable battery can be analyzed especially well with this current-voltage characteristic curve, especially when it is captured in a time-indexed manner.

According to a further variant, the charge and/or discharge current is modified in that, by means of an electric converter, an alternating current with variable frequency and amplitude is superimposed over a DC voltage. The alternating current is preferably sinusoidal.

In this case, the complex alternating current resistance of the rechargeable battery is determined as a characteristic variable.

By varying the frequency of the superimposed alternating current and simultaneously measuring current and voltage, this in-situ operation corresponds to the method of electrochemical impedance spectroscopy. Performing this operation multiple times while varying frequency and amplitude results in characteristic curves, which, when associated with temperature and charging status, can provide information about the age deterioration status of various components of the battery. The battery provides the temperature and charging status information via its BMS (Battery Management System).

It is advantageous for measurement data recorded in the one electric converter or each of the multiple electric converters to be evaluated in the control unit.

Alternatively or additionally, measurement data captured in the one electric converter or each of the multiple electric converters can be read by an external computing unit, wherein the computing unit is designed to evaluate the measurement data.

In particular, the computing unit can be part of a cloud.

Coupling to the computing unit can be implemented with a wireless data transmission path, wherein especially radio signals are used for data transmission.

This enables flexible evaluation of the data from the rechargeable batteries that takes place in a location spatially completely separate from the device.

The measurement data can be transmitted continuously or only during maintenance procedures.

It is advantageous for the measurement data to include an individual identifier for each respective rechargeable battery.

This way, the measurement data are uniquely assigned to the rechargeable battery for which it was recorded. The measurement data can therefore be used specifically to monitor the age deterioration status of this rechargeable battery.

It is further advantageous for the measurement data to be transmitted in encrypted form.

This way, solely authorized persons can receive access to the measurement data.

According to an advantageous embodiment, guidelines or action recommendations for the operation of rechargeable batteries can be derived from the measurement data, which guidelines or action recommendations serve to extend the service life of the rechargeable batteries.

It is further advantageous that information for further development of rechargeable batteries can be derived from the measurement data.

This way, development processes for developing rechargeable batteries can be structured significantly more efficiently.

In an arrangement of multiple rechargeable batteries operated in cyclical operation, it is especially advantageous for energy from one respective battery to be fed into the other respective batteries, by which means these other batteries are warmed.

This cyclical operation is performed such that within each cycle, each battery sends energy to the respective other batteries one time. This operation is maintained for a preset time in order to efficiently warm cold batteries. The batteries warmed in this manner perform better in charging and discharging processes than batteries that are too cold.

This operating mode exploits the circumstance that in a battery in a cold state the technically permitted discharge current is significantly greater than the charge current.

This operating mode functions especially well when at least three batteries are provided.

The invention is explained below based on the drawings. They show:

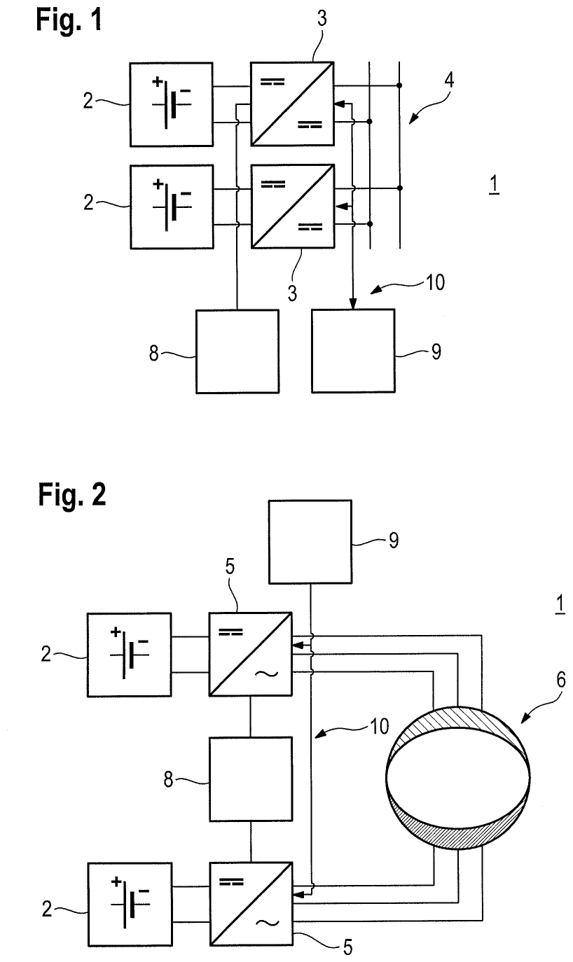

FIG. 1: First exemplary embodiment of the device according to the invention.

FIG. 2: Second exemplary embodiment of the device according to the invention.

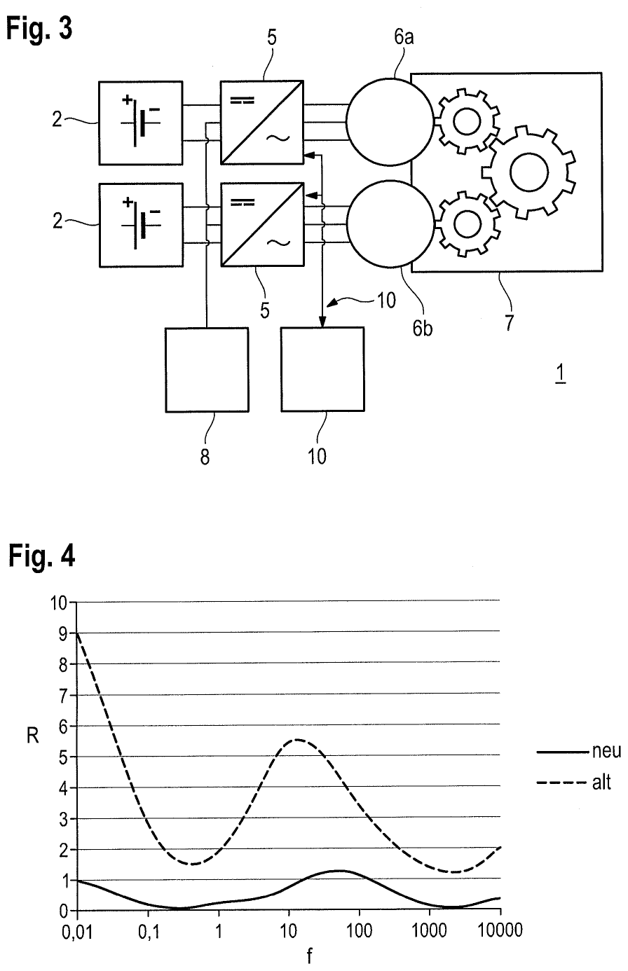

FIG. 3: Third exemplary embodiment of the device according to the invention.

FIG. 4: Depiction of the curve representing the complex resistance of a rechargeable battery as a function of the modulated frequency of a superimposed alternating current.

FIGS. 1 to 3 show three exemplary embodiments of the device 1 according the invention. Each of the devices 1 from FIGS. 1 to 3 has an arrangement of multiple rechargeable batteries 2, which can be lithium-ion batteries, for example. In the present case, the multiple rechargeable batteries 2 within an arrangement are identical, however this is not necessary.

In general, a device 1 can also have just one rechargeable battery 2. Equally, the device 1 can have more than two rechargeable batteries 2.

In all exemplary embodiments, each rechargeable battery 2 is assigned an electric converter for coupling to a superordinate system.

The rechargeable batteries 2 are operated with the respectively assigned electric converter such that the rechargeable batteries 2 can be charged with a charge current or energy can be drawn from the rechargeable battery 2 with a discharge current in order to feed it to the superordinate system.

In the device from FIG. 1, each rechargeable battery 2 is assigned an electric converter in the form of a DC/DC converter 3. In this case, the superordinate system is provided in the form of a DC voltage grid 4. This can then drive motors via DC/AC converters or form an isolated grid or feed energy into a public grid.

In the device 1 from FIG. 2, each rechargeable battery 2 is assigned an electric converter in the form of a DC/AC converter 5. In this case, the superordinate system is provided in the form of a motor 6. Energy is fed into separate partial windings of the motor 6 via the DC/AC converters 5.

In the device 1 from FIG. 3 as well, each rechargeable battery 2 is assigned an electric converter in the form of a DC/AC converter 5. The superordinate system is provided in the form of two motors 6a, 6b that are coupled via a summation transmission 7. A motor 6a, 6b is driven with each DC/AC converter 5.

According to the invention, characteristic variables, on the basis of which information about the operating status of the assigned rechargeable battery 2 can be determined, are captured by the electric converters.

The age deterioration status of the one rechargeable battery 2 or of each of the multiple rechargeable batteries 2 is determined by means of the characteristic variables.

Moreover, age deterioration-related operating modes of the one rechargeable battery 2 or of each of the multiple rechargeable batteries 2 are determined by means of the characteristic variables.

To accomplish this, sensors are provided for measuring characteristic variables, which sensors are integrated into or assigned to an electric converter.

Moreover, according to the invention, the operating mode of the rechargeable battery 2 is influenced, especially upon the basis of the recorded characteristic variables.

The operating mode of the one rechargeable battery 2 or of each of the multiple rechargeable batteries 2 is influenced such that its/their service life is extended.

Suitable control means are provided for influencing the operating mode of the rechargeable battery 2. In general, such means can be constituted by the electric converters themselves.

Alternatively or additionally, a control unit 8 that is connected to the electric converter is provided as control means, as shown in FIGS. 1 to 3.

The control means are used to specifically modify the operating mode of the rechargeable battery 2 such that its useful life or service life is extended. It is advantageous for the control to occur upon the basis of the recorded characteristic variables.

With regard to the devices 1 from FIGS. 1 to 3, when the operating mode of one of the rechargeable batteries 2 is controlled such that its service life is extended, the other rechargeable batteries 2 are controlled such that the required properties of the overall system remain unimpaired by this.

The control unit 8 can also be used to evaluate measurement data generated by the electric converters. In the present case, a computing unit 9 that is connected to the electric converters via a bidirectional data transmission path 10 is provided for this purpose (FIGS. 1 to 3). The data transmission path 10 can be wired. In the present case, the data transmission path 10 is wireless, wherein it is advantageous for data to be transmitted across the data transmission path 10 in the form of radio signals. The computing unit 9 can be a cloud computer of a cloud.

It is advantageous for the measurement data for a rechargeable battery 2 to be identified by a unique identifier that uniquely identifies the rechargeable battery 2, such that the measurement data can be uniquely assigned to the rechargeable battery 2 during the evaluation.

It is further advantageous for the measurement data to be transmitted across the data transmission path 10 in encrypted form, such that solely authorized persons have access to the measurement data.

In general, the measurement data can be transmitted continuously from the electric converters to the computing unit 9. Alternatively, the measurement data can be transmitted only during a discrete time interval, such as during maintenance procedures.

In the present case, current and voltage of a rechargeable battery 2 are captured as characteristic variables.

To record characteristic variables of a rechargeable battery 2, the charge and/or discharge current thereof can be modified by means of an electric converter. By modifying the charge and/or discharge current of the rechargeable battery 2, the voltage is determined upon the basis of the current.

Moreover, the charge and/or discharge current can be modified in that an alternating current with variable frequency and amplitude is superimposed over a DC voltage by means of an electric converter.

In this case, the complex alternating current resistance of the rechargeable battery 2 is determined as a characteristic variable.

A result of such an analysis is shown in FIG. 4.

FIG. 4 shows the curve of the determined complex resistance R in mOhm across the modulation frequency fin Hz of a superimposed alternating current.

As is evident from FIG. 4, the frequency-dependent curve of the alternating current for an old rechargeable battery 2 in which the age deterioration process is already advanced differs significantly from the curve for a new rechargeable battery 2.

Information about the age deterioration of individual components of the rechargeable battery 2 can be gained through such analyses, preferably analyses depending upon the charging status and temperature of the rechargeable battery 2.

This includes age deterioration of the cathode and anode of the rechargeable battery 2 as well as the chemical decomposition of the electrolytes of the rechargeable battery 2. This further includes the age deterioration of separators, which results in an increase in the charge transfer resistance for ions of the rechargeable battery 2. Finally, age deterioration of passive components, such as binders, can be captured.

The determined characteristic variables can be evaluated in the computing unit 9 for various purposes.

In particular, guidelines or action recommendations for the operation of rechargeable batteries 2 can be obtained from the measurement data in order to extend the service life of rechargeable batteries 2.

Furthermore, information for the further development of rechargeable batteries 2 can be derived from the measurement data.

### LIST OF REFERENCES

(1) device
(2) rechargeable battery
(3) DC/DC converter
(4) direct current grid
(5) DC/AC converter
(6) motor
(6a) motor
(6b) motor
(7) summation transmission
(8) control unit
(9) computing unit
(10) data transmission path
R resistance
f modulation frequency

1. A device with at least one rechargeable battery and an electric converter assigned thereto, wherein the electric converter is connected to a superordinate system, wherein the electric converter is configured to draw electric energy from the rechargeable battery or to feed energy into the rechargeable battery such that that characteristic variables of the rechargeable battery are determined during its operation by the electric converter and/or means for influencing an operating mode of the rechargeable battery are provided.

2. The device according to claim 1, wherein the at least one rechargeable battery comprises an arrangement of multiple rechargeable batteries, wherein each of the multiple rechargeable batteries is connected to the superordinate system via the electric converter.

3. The device according to claim 1 wherein one electric converter or each of multiple electric converters is comprises a DC/DC converter, which is connected especially to a direct current grid.

4. The device according to claim 1 comprising sensors that are integrated into or assigned to the electric converter are configured to measure characteristic variables, and/or that current and voltage are captured as characteristic variables of the at least one rechargeable battery.

5. The device according to claim 1, wherein to record characteristic variables of the rechargeable battery, a charge and/or discharge current thereof is modified by the electric converter, and that by modifying the charge and/or discharge current for the rechargeable battery, the current is determined based on the current, and/or that the charge and/or discharge current is modified in that an alternating current with a variable frequency and amplitude is superimposed on a direct current by the electric converter, and/or that a complex alternating current resistance of the rechargeable battery is determined as a characteristic variable.

6. The device according to claim 1, wherein an age deterioration status of the at least one rechargeable battery or of each of multiple rechargeable batteries is determined from the characteristic variables, and/or age deterioration-related operating modes of the at least one rechargeable battery or of each of the multiple rechargeable batteries are determined of from the characteristic variables.

7. The device according to claim 1, wherein the operating mode of the at least one rechargeable battery or of each of multiple rechargeable batteries is influenced such that a service life of the at least one rechargeable battery or each of the multiple rechargeable batteries is extended.

8. The device according to claim 2, wherein at least one of multiple electric converters constitutes a control means for influencing the operating mode of the at least one rechargeable battery or of each of the multiple rechargeable batteries, or that a control unit connected to at least one of the multiple electric converters is provided for influencing the operating mode of the at least one rechargeable battery or of each of the multiple rechargeable batteries.

9. The device according to claim 1, wherein the at least one rechargeable battery comprises an arrangement of multiple rechargeable batteries, and the operating modes thereof are influenced such that the superordinate system is unimpaired.

10. The device according to claim 8, wherein measurement data recorded in at least one of multiple electric converters is evaluated in the control unit.

11. The device according to claim 1, wherein measurement data captured in at least one of the one electric converter or in each of the multiple electric converters is read by an external computing unit, wherein the computing unit is configured to evaluate the measurement data, and/or is part of a cloud.

12. The device according to claim 10, wherein the measurement data contains an individual identifier for the respective rechargeable battery, or that the measurement data are transmitted in encrypted form.

13. The device according to claim 10, wherein the measurement data are transmitted continuously or only during service procedures.

14. The device according to claim 10, wherein guidelines or action recommendations for the operation of rechargeable batteries is developed based on the measurement data in order to extend service life of the rechargeable batteries, and/or that information for further development of rechargeable batteries is derived from the measurement data.

15. The device according to claim 2, wherein the arrangement of multiple rechargeable batteries in cyclical operation, energy is respectively fed from one battery to respective other batteries, by which means the other batteries are warmed up.

16. The device according to claim 2, wherein at least one of the multiple electric converters is constituted by a DC/DC converter, which is connected especially to a direct current grid.

17. The device according to claim 2, comprising sensors that are integrated into or assigned to the electric converter are configured to measure characteristic variables, and/or that current and voltage are captured as characteristic variables of the at least one rechargeable battery.

18. The device according to claim 2, wherein to record characteristic variables of the rechargeable battery, a charge and/or discharge current thereof is modified by the electric converter, and that by modifying the charge and/or discharge current for the rechargeable battery, the current is determined based on the current, and/or that the charge and/or discharge current is modified in that an alternating current with a variable frequency and amplitude is superimposed on a direct current by the electric converter, and/or that a complex alternating current resistance of the rechargeable battery is determined as a characteristic variable.

19. The device according to claim 2, wherein an age deterioration status of the at least one rechargeable battery or of each of the multiple rechargeable batteries is determined from the characteristic variables, and/or age deterioration-related operating modes of the at least one rechargeable battery or of each of the multiple rechargeable batteries are determined from the characteristic variables.

20. The device according to claim 2, wherein the operating mode of the at least one rechargeable battery or of each of the multiple rechargeable batteries is influenced such that a service life of the at least one rechargeable battery or each of the multiple rechargeable batteries is extended.
